(19) United States
(12) Patent Application Publication
(10) Pub. No.: US 2014/0136323 A1
(43) Pub. Date: May 15, 2014

(54) SYSTEM AND METHODS FOR ADVERTISING BASED ON USER INTENTION DETECTION

(71) Applicants: Guangsheng Zhang, Palo Alto, CA (US); Chizhong Zhang, Palo Alto, CA (US)

(72) Inventors: Guangsheng Zhang, Palo Alto, CA (US); Chizhong Zhang, Palo Alto, CA (US)

(21) Appl. No.: 13/844,982

(22) Filed: Mar. 17, 2013

Related U.S. Application Data
(63) Continuation of application No. 13/798,258, filed on Mar. 13, 2013.
(60) Provisional application No. 61/698,640, filed on Sep. 9, 2012.
(60) Provisional application No. 61/682,205, filed on Aug. 11, 2012.

(51) Int. Cl. G06Q 30/02

(52) U.S. Cl. CPC G06Q 30/0255
USPC 705/14.53

(57) ABSTRACT

System and methods are disclosed for advertising based on user intention detection. The methods include performing linguistic analysis of user expressions, identifying grammatical or semantic attributes associated with terms in the expression, and their relationships, and determining a relevance score for one or more terms in the expression that are associated with the name of a product or service. Based on the relevance score, an advertisement can be displayed to the user who produced the expression within a given period of time. The user can be a social network user, or an email user, or a text messaging user, or a user of other text communication media. Furthermore, electronic advertising space or time can be sold or auctioned to advertisers based on the relevance score in contrast to the conventional method of being based on keywords. Furthermore, based on the number of users having produced an expression indicating an intention to purchase a similar product or service, an advertiser can determine a group purchase price based on the number of users having indicated such an intention. Furthermore, dynamic user profiles can be created or updated based on the detection of user interest, and suggestions and recommendations can be made to users of social networks and other media channels accordingly.

### CROSS REFERENCES TO RELATED APPLICATIONS

The present application is a Continuation Application of and claims priority to U.S. patent application Ser. No. 13/798,258 entitled “System and Methods for Determining User Interest or Intention Based on User Expressions” filed on Mar. 13, 2013. U.S. patent application Ser. No. 13/798,258 claims priority to U.S. Provisional Patent Application 61/698,640 entitled “System and methods for quantitatively determining the likelihood of a user purchasing a commodity based on a user expression” filed on Sep. 9, 2012, and U.S. Provisional Patent Application 61/682,205 entitled “System and methods for determining term importance and relevance between text contents using conceptual association datasets” filed on Aug. 11, 2012, the disclosures of which are incorporated herein by reference.

### BACKGROUND OF THE INVENTION

A key problem with conventional online targeted advertisement systems is that ads can often be extremely irrelevant to the targeted users, which can result in very low user response, but a high cost to the advertisers.

Many of these systems use keyword matching and the frequency of the keyword used by the user within the text content as an indicator of relevancy, but this method has the problem of not knowing if the targeted user really wishes to purchase the keyword-related product. Other systems may infer the user intention by looking at certain phrases in a user expression, such as “I want to buy a car”, or “I like gardening”, etc, as an indication of the user's intention or interest. These methods are limited to the specific words used, and more limited due to the lack of deeper analysis of grammatical, semantic, and contextual information in the user expression.

Certain conventional approaches reply on the distance or proximity of certain keywords in the expression without a more detailed analysis of the linguistic structure of the expression. Others may use a conventional method of n-gram-based text chunking for statistical analysis, which lacks the ability in capturing the true meanings of the words or phrases used in the expression. For example, if the analyzed phrase is “I wanted to buy a car before,” or “I used to like gardening”, etc, the grammatical and semantic difference between “want to buy” and “wanted to buy”, or “like” and “used to like” may not be captured by using conventional methods, but it is apparent that even though words such as “buy” and “like” are all present, the user's intention to purchase something related to a car or gardening is very different in the two cases. Thus if the difference cannot be captured or the user's true interest or intention cannot be accurately detected, the relevance of the ads being displayed can be significantly impaired.

### SUMMARY OF THE INVENTION

The present invention provides a system and methods for accurately determining the likelihood of a user making a purchase of a targeted goods or service, or being interested in something, based on a deep analysis of the grammatical, semantic, and contextual information of the expressions a user makes when such an expression is available for the advertising purposes, whether such expression are made in real-time, such as a user making a comment on a social network, in an email, a short message, or a collection of such expressions made within a given time period.

In a general aspect, a user expression is broken down into sentences, and a sentence is parsed to identify the meaningful units of words or phrases and their structural relationships. Terms in the sentence are further analyzed based on the associated grammatical or semantic attributes in the specific context, and importance scores are assigned to the terms based on such attributes. A relevance score is calculated based on the importance scores of the terms in the expression, and terms that are identified as being relevant to an advertisable product or service are selected if the relevance score is above a threshold, and related advertisement can be displayed to the user.

In another general aspect, applications of the methods are extended to areas including selling or auctioning the advertising time or space based on the relevance score, in addition to the relevant terms as keyword for advertising.

In another general aspect, applications of the methods are extended to areas including promoting a commodity with a group purchase price based on the number of users having produced expressions that indicate a high likelihood of purchasing a product or service, in addition to the relevant terms as keyword for advertising.

In another general aspect, applications of the methods are extended to areas including dynamically creating or modifying user profiles based on what the users actually say, and recommendations or suggestions are made based on the detected user interests.

In another general aspect, applications of the methods are extended to areas including dynamically recommending or suggesting for social network users to expand their friend circles, forming groups or communities based on what the users actually say, and the detected user interests.

### BRIEF DESCRIPTION OF FIGURES

The following drawings, which are incorporated in and form a part of the specification, illustrate embodiments of the present invention and, together with the description, serve to explain the principles of the invention.

FIG. 1 is a flow diagram illustrating the overall process of estimating the likelihood of a user making a purchase based on a user expression and the grammatical and/or semantic attributes of the terms in the expression, and then displaying an advertisement if the likelihood score is above a threshold.

FIG. 2 is an illustration of an exemplar embodiment of determining relevant advertising based on the grammatical attributes of terms in a user expression.

FIG. 3 is an illustration of another exemplar embodiment of determining relevant advertising based on semantic attributes of terms in a user expression.

FIG. 4 is an illustration of different groupings of terms based on semantic characteristics.

FIG. 5 is an illustration of an exemplar embodiment in determining relevance for advertising based on grammatical and semantic attributes.

FIG. 6 is a system diagram in accordance with one embodiment of the present invention.

FIG. 7 is an illustration of a method to determine relevant group promotions based on multiple user expressions.

### DETAILED DESCRIPTION OF THE INVENTION

An expression is a linguistic object produced by a user at any given time under any given context. An expression can be one or more words, phrases, sentences, paragraphs, etc. For ease of illustration, in the present disclosure, the example expressions are simple sentences in the English language. It should be noted that the system and methods disclosed in the present invention can be equally applied to any other languages, and in any forms other than simple sentences.

In some other embodiments, an advertisable commodity name list is first obtained or compiled, and the expression is analyzed when it contains an advertisable commodity name.

In some embodiments, user expressions are first broken into sentences, and a sentence structure or pattern is identified for analysis.

The present invention first identifies the components of a sentence, such as a word, a phrase, etc., by tokenizing such components into instances of terms, each of which can contain one or more words, and then identifies the grammatical attributes and roles of these components. The grammatical attributes include what is known as the parts of speech, such as a noun, a pronoun, a verb, an adjective, adverb, a preposition, etc., and the grammatical roles can include whether a word or phrase is the subject of a sentence, or predicate of a sentence, a direct object, or an indirect object, or a sub-component of the subject or predicate phrase, etc. In the present invention, the predicate of a sentence can be defined as the rest of the sentence other than the subject. For example, in the sentence of “I like digital cameras”, “I” is the subject, and “like digital cameras” is the predicate of the sentence.

In some embodiments, the present system further identifies the components of a predicate as comprising a transitive verb signifying an action or a relation, plus a noun or a noun phrase as direct or indirect object of the transitive verb, such as in “I bought a camera” in which the word “bought” is an action verb, and the “camera” is a direct object of the verb; or an intransitive verb without an object noun, such as in “The camera broke”; or a linking verb plus an adjective, a noun or noun phrase, such as in “Camera is good”, in which “is” is a linking verb, and “good” is an adjective functioning as a predicative, or other components as the complement of the adjective of the linking verb, such as “the book is easy to understand”, in which “easy to understand” can be a complement of the adjective ‘easy”. In some embodiments, the adjective following a linking verb is called a “predicative”.

In one embodiment, the system further identifies the grammatical roles of the sub-components of a multi-word phrase, whether the phrase is a subject, or a predicate, or a direct object, or an indirect object of the sentence. In the present invention, a multi-word phrase is defined as having a grammatical structure consisting of a head plus one or more modifiers. For example, in the phrase of “digital cameras”, the word “digital” is a modifier, and the word “cameras” is the head of the phrase.

In the present invention, identifying such grammatical components is important in determining how likely the user who produced the expression will make a purchase of a commodity mentioned in the expression, or associated with what is mentioned in the expression, or is interested in something, and further determining whether an advertisement should be displayed to the user, or what kind of advertisement is to be displayed. For example, compare the sentences of

(1) “I want to buy a computer.”
(2) “They want to buy a computer.”

Without performing a grammatical analysis to identify what the subject of each sentence is, an advertisement of computer may be displayed to the person who produced these sentences. In (1), the subject of the sentence is “I”, thus an advertisement for computer displayed to this person can be considered relevant. However, in (2), the subject of the sentence is “they”, and if the display of ads is solely dependent on the word “computer”, in many cases, the ads may not be so relevant to the person who produced this sentence.

Furthermore, identifying the grammatical role of object of the verb “buy” is also important, for example:

(3) “The restaurant wants to buy a computer.”

Without correctly distinguishing the subject of the sentence (“restaurant”) from the object of the verb (“computer”), an ad for a restaurant may be displayed instead of an ad for a computer, and the result can be very irrelevant.

In some embodiments, semantic analysis can be performed to identify the meanings of the words and their relationships. For example,

(4) “I have a computer, but I don't have a printer.”

Without correctly interpreting the meaning of “have” as “possessing something”, an advertisement for either a computer or printer can be displayed, but ads for computers in this case will be much less relevant than ads for printers.

In some embodiments, contextual analysis can be performed to identify the change in meanings of the words under specific context. For example,

(5) “I don't like computers”
(6) “I don't like computers if they are too heavy to carry”.

If one only looks at “don't like computers” in both (5) and (6), an advertiser may think that no computer ads should be displayed since the user displayed no interest in computers. However, when context information is identified, ads for computers that are not considered heavy, such as light-weighted laptop computers can be effectively displayed as being relevant when the expression produced by the user is (6).

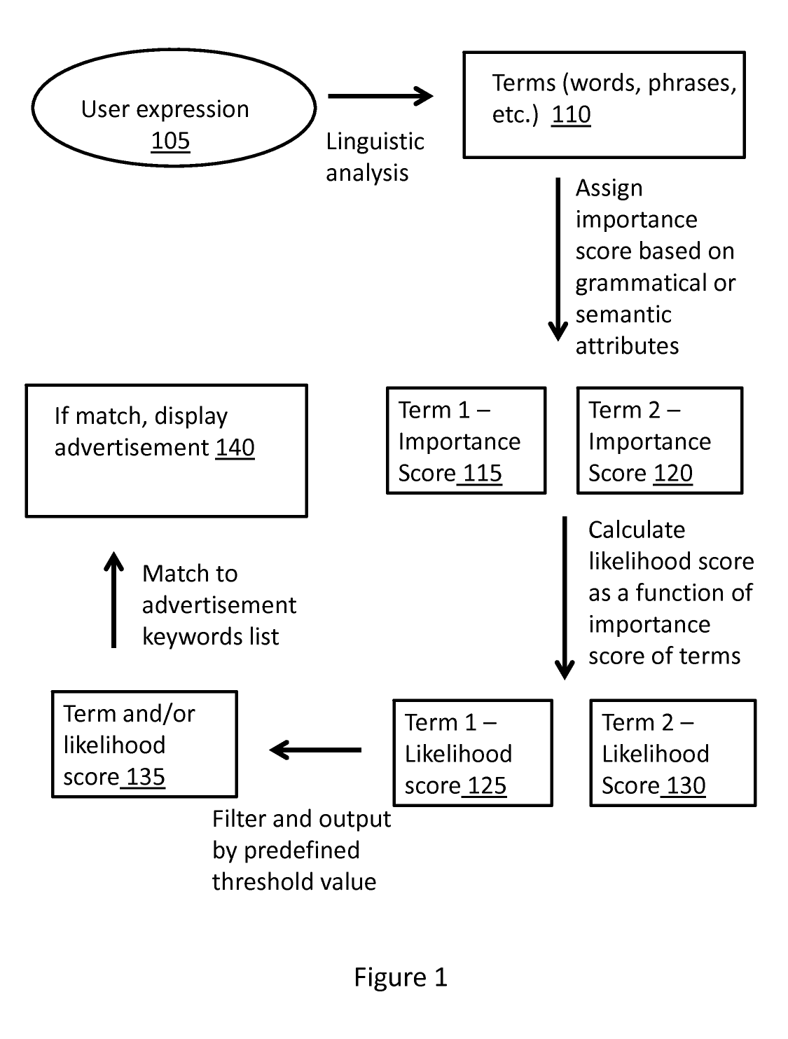

FIG. 1 is a general flow diagram of one embodiment of the present invention. It illustrates the overall process of estimating the likelihood of a user making a purchase based on a user expression and the grammatical and/or semantic attributes of the terms in the expression, and then displaying an advertisement if the likelihood score is above a threshold. In FIG. 1, a use expression (105) is obtained, and is tokenized in to terms (110). Then, grammatical or semantic attributes associated with the terms are identified, and each term can be assigned an importance score (115, 120) based on the grammatical or semantic attributes, such as whether the subject is a first person pronoun, or a third person pronoun, or whether the verb indicates an intention to purchase something, etc. Then, a likelihood score (125), (130) can be calculated for one or more terms in the expression, or for the expression itself, which may contain one or more names of advertisable commodities. Then one or more terms can be selected (130) and output if the relevance score is above a threshold, and can be matched with an advertisement database. If one or more selected terms match an advertisement in the database, the advertisement can be displayed to the user.

In some embodiments, the likelihood of a user buying something can be estimated by the various grammatical attributes of the words and phrases used in the expression. For example, compare sentences (7) and (8) below.

(7) I need a computer.
(8) They need a computer.

In (7), the subject is “I”, and its grammatical attribute of parts of speech is a pronoun, more specifically, it is a first person nominative pronoun. In (8), the subject is “they”, which is also a pronoun in nominative case, but it is a third person nominative pronoun. The present invention can algorithmically assign a larger numeric value as an importance score to a first person nominative pronoun, and a relatively smaller value to a second or third person nominative pronoun to estimate the relevance. Furthermore, a larger numeric value can be assigned to a regular or proper noun (such as “computer” in this case) as its importance score; and a relatively smaller value can be assigned to a pronoun or a personal pronoun (such as “I” or “they” in this case) as its importance score. Furthermore, as will be described in more detail below with semantic attributes, different values can be assigned to verbs of various kinds. In this particular example, the verb “need” is associated with a meaning of “having a need of something”, and can be assigned a relatively greater value as its importance score than some other words such as “clean” in “I/they may clean the computer”.

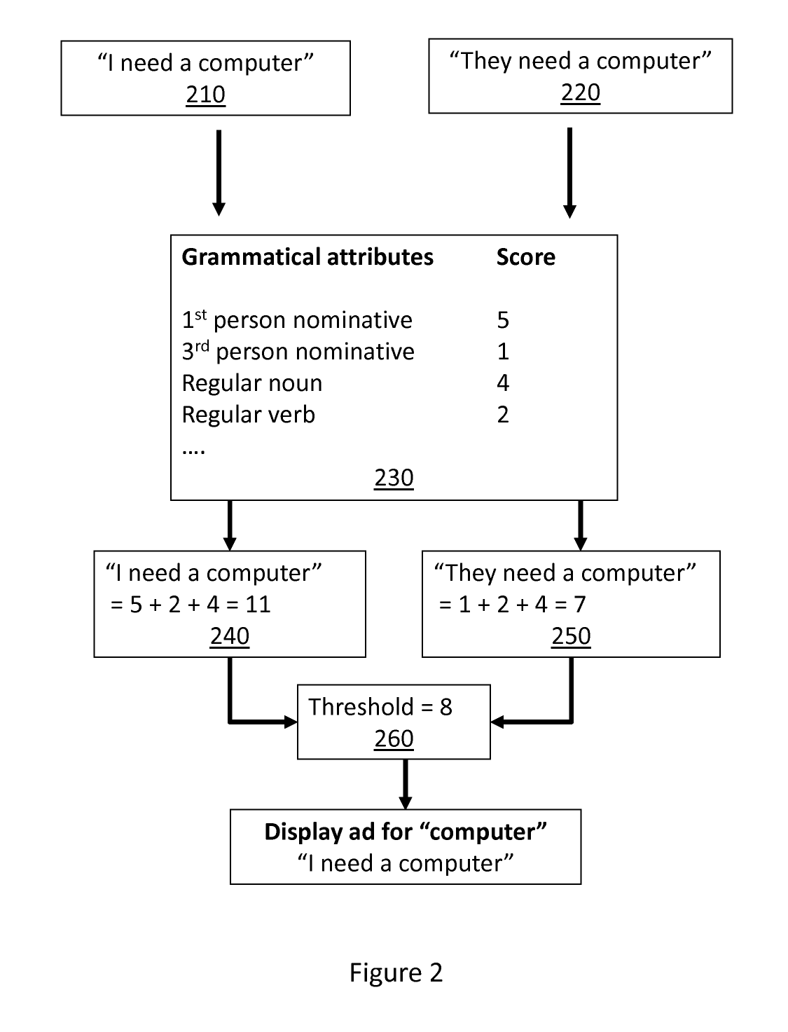

When the importance scores are assigned to the words or phrases in the expression based on their grammatical attributes, an overall score of the expression or an overall score of a target word or phrase in the expression can be calculated as a function of the importance scores of one or more individual words and phrases. FIG. 2 illustrates one embodiment of the present invention where scores are assigned to individual words based on grammatical attributes. Sentence 210 of “I need a computer” and sentence 220 of “They need a computer” can be broken into its component terms, and meaningful terms can be identified by a structural analysis process such as syntactic parsing process, and be assigned scores based on the grammatical attributes identified with the terms. The grammatical attributes 230 can be identified by a parser program with information from a dataset such as a dictionary. Dataset can be stored in an internal or external file, database, or other storage system. For example, if the importance score for the first person nominative pronoun “I” is 5, and that for a third person nominative pronoun (“they”) is 1, and that for a regular noun is 4, and that for a regular verb is 2, then by adding the importance scores of all the elements that have a non-zero score value, an overall score 240 of 5+2+4=11 can be obtained for sentence 210 and an overall score 250 of 1+2+4=7 can be obtained for sentence 220.

In the present invention, scores like these two can be used as an estimate of the likelihood of the user buying a computer within a reasonable amount of time. If a threshold 260 is predefined, such as being 8, then sentence 210 can be selected as a relevant context for advertising for computer as a product or commodity. And if the word “computer” in sentence 210 matches a target keyword or the description of an advertisement associated with the commodity of computer, then such an advertisement can be displayed to the user either dynamically at the time the user makes an expression like sentence 210, or during a pre-defined period of time after the user has made such an expression.

The above is only a simple example for the purpose of illustrating how grammatical attributes of words and phrases in a user expression, such as what type of noun or pronoun and whether a noun or pronoun is a subject or object, together with what verbs are used in the expression, can be used to obtain an estimate of the likelihood of the user making a purchase of something. In implementation, score values, same or different, can be assigned to words or phrases with other grammatical attributes that are not exhaustively listed or exemplified here. And the range for the score values can be predetermined to be either an integer range, or decimal range, and the final scores can be normalized in various ways.

### Semantic Analysis and Weighting Scores Based on Meanings of Terms

In some other embodiments, semantic and contextual analysis can be performed to more accurately determine the likelihood of the person making a purchase based on an expression the person has made. When conventional methods may utilize the information about the presence of certain words as indication of a user's intention to buy something, such as the English words like “buy” or “purchase”, the present invention further determines to what degree of likelihood that the user may actually buy something, not only based on the grammatical attributes of various words or phrases used in the user expression, but also based on their semantic attributes and relationships. For example, in the following sentences,

(9) “My computer is very slow.”
(10) “My new cell phone is great.”

A person with sufficient knowledge in English will likely determine that the likelihood of the speaker or user buying a computer is much higher than buying a cell phone. This is because the user's intention can be inferred from the meanings of the words or phrases used in the expression. As will be described below, when the meanings of the words and phrases in the expression can be captured with a sufficient degree of accuracy by a computer-assisted method such as the methods disclosed in the present invention, the likelihood of the speaker either buying a computer or a cell phone can also be accurately estimated by a computer program without human intervention.

In sentence (9), the user indicates that he or she has a computer, and the computer is slow, which further implies that the user is not happy about the computer he/she currently possesses. In (10), the user indicates that he or she has a new cell phone, and the cell phone is great, which further implies that the user is happy or satisfied about the cell phone he/she currently possesses. The present invention can algorithmically determine that when a user is not satisfied with something he/she already has, the likelihood of purchasing an alternative is relatively high, or at least higher than the likelihood when the user is satisfied with the goods or service the user already has.

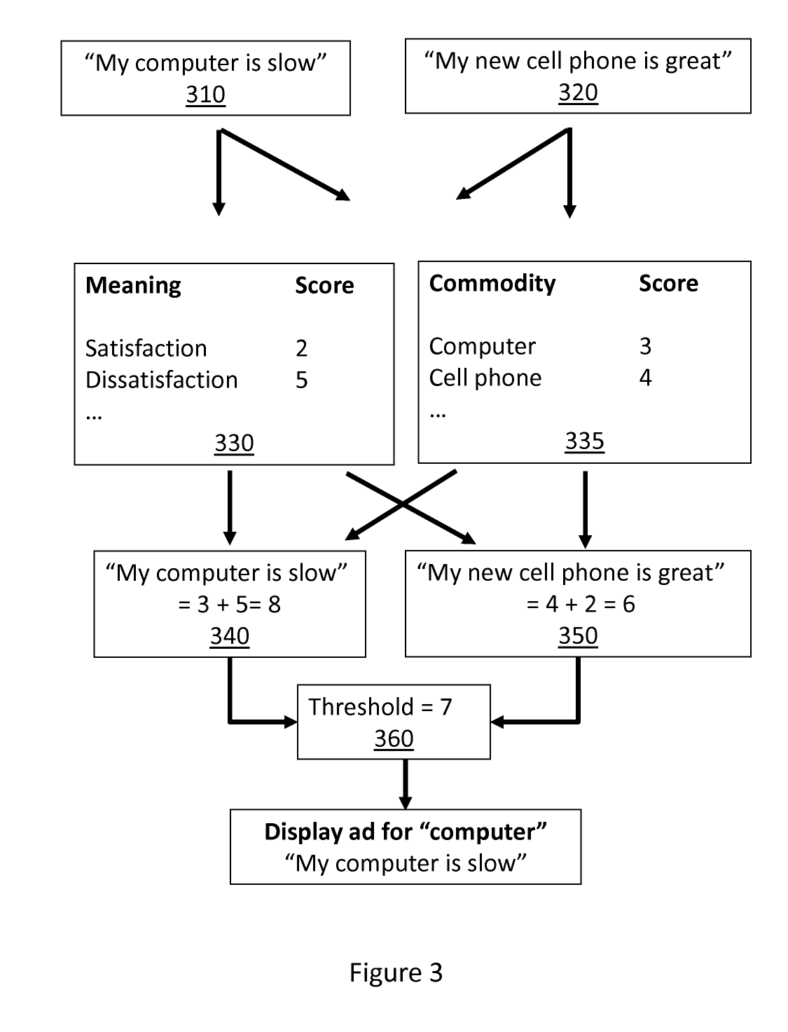

In the present invention, numerical values are assigned to words or phrases according to their meanings. For the purpose of determining the likelihood of a user making a purchase of a commodity, a word or phrase indicating a feeling of satisfaction towards a commodity they already have may be assigned a smaller value as its importance score, and a word or phrase indicating a feeling of dissatisfaction towards something they already have may be assigned a larger value as its importance score. FIG. 3 is an illustration of one embodiment of the present invention where importance values are assigned to words based on their meanings. In FIG. 3, sentences 310 and 320 are broken into their component terms. Dataset 330 comprises information about semantic attributes and score values. Dataset 335 comprises information about commodity names and score values. In sentence 310, the word “slow” can be assigned a value of 5, and in sentence 320, the word of “great” can be assigned a value of 2, as their term importance scores for the purpose of determining the likelihood of the user making a purchase. In addition to these words, the word “computer” can be assigned a value of 3 based on it's being the name of a specific type of commodity, and the word “cell phone” can be assigned a value of 4 based on its being the name of another type of commodity which may be different from a computer in terms of price, usage, or purchase frequency, etc.

Then, as is described above with the grammatical analysis, an overall score of the expression or an overall score of a target word or phrase in the expression can be calculated as a function of the importance scores of one or more words or phrases in the expression, and can be used as a quantitative estimate of the likelihood of the user making a purchase of a targeted commodity. For example, the overall score 340 for sentence 310 can exemplarily be 3+5=8, and the overall score 350 for sentence 320 can exemplarily be 4+2=6. The two scores can be used as an estimate of the relative likelihood of the user buying a computer or a cell phone, respectively. Again, a threshold can be determined, and the expression or the target term that has a score above the threshold can be considered relevant context for displaying an advertisement for the commodity the name of which is contained in that expression. In this example, an advertisement for computer can be considered more relevant than an advertisement for cell phone in this specific context.

In the present invention, a dictionary or word list is first compiled containing one or more words used in a language, storing their meanings which can provide clues in determining the likelihood of the user buying something, and optionally, a numerical value can be attached to each word in the list or dictionary to indicate how strong the tendency of making a purchase can be inferred from an expression with the presence of the word. In the present invention, the methods for selecting which word or words to be included in the list or dictionary, and what numerical values to be assigned to each word are based on a number of principles as exemplarily described below.

The present invention identifies a number of factors and their linguistic indicators that can contribute to a user's purchasing decision. As is known in common psychology, humans have needs, and they purchase goods/services to meet their needs, fill their deficiency, or achieve satisfaction at various levels. And humans also have different interests, and they purchase goods/services to satisfy their interest as well.

One embodiment of the present invention is to identify words or phrases of a language that indicate a need, or a deficiency, or a desire, or an interest, such as the English words “need”, “want”, “lack”, “not enough”, “bad”, “desire”, “interested in”, “like”, etc., and optionally, pre-assign a numerical value to each of such words as their default importance score for the purpose of determining the likelihood of making a purchase when such words are used under certain context.

Another embodiment of the present invention is to identify words or phrases of a language that indicate a sufficiency, or satisfaction. For example, English words such as “enough”, “great”, ‘good”, “happy”, “satisfied”, “comfortable”, “not bad”, etc., can be identified as belonging to this category. Optionally, a numerical value can be pre-assigned to each of such words as their default importance score for the purpose of determining the likelihood of making a purchase when such words are used under certain context.

Another embodiment of the present invention is to identify words or phrases that indicate a state of possession of some commodity. For example, English words or phrases such as “have”, “has”, “had”, “possess”, “got”, “gotten”, etc., can be identified as belonging to this category. Optionally, a numerical value can be pre-assigned to each of such words as their default importance score for the purpose of determining the likelihood of making a purchase when such words are used under certain context.

Another embodiment of the present invention is to identify words or phrases of a language that indicate an action to acquire or to remove. For example, English words such as “buy”, “purchase”, ‘own”, “remove”, “get rid of”, “dispose”, “throw away”, etc., can be identified as belonging to this category. Optionally, a numerical value can be pre-assigned to each of such words as their default importance score for the purpose of determining the likelihood of making a purchase when such words are used under certain context.

Another embodiment of the present invention is to identify words or phrases that indicate a state of intention or plan for action. For example, English words or phrase such as “going to”, “plan to”, “about to”, “let's”, etc., can be identified as belonging to this category. Optionally, a numerical value can be pre-assigned to each of such words as their default importance score for the purpose of determining the likelihood of making a purchase when such words are used under certain context.

Another embodiment of the present invention is to identify words or phrases that indicate a point of time in the past, present, or future, and time duration, as an indication of the likelihood of purchasing certain goods/service at certain point of time. For example, English words or phrase such as “now”, “yesterday”, “next week”, “next month”, etc., can be identified as belonging to this category. Optionally, a numerical value can be pre-assigned to each of such words as their default importance score for the purpose of determining the likelihood of making a purchase when such words are used under certain context. For example, a future tense can imply a planned action, thus is more likely to have a yet-to-be-met need. On the other hand, a past action may imply a generally lower probability that the action will be repeated any time soon, while in some cases, certain action do repeat often.

A related embodiment to using future tense or time expression is to analyze the text expressions in a user's electronic calendar or task list, based on the assumption that calendar events and tasks are future events being planned, and are more likely related to some yet-to-be-met needs, thus providing an advertising opportunity.

Another embodiment of the present invention is to identify words or phrases that indicate a state of urgency for action. For example, English words or phrases such as “desperately”, “urgently”, etc., can be identified as belonging to this category. Optionally, a numerical value can be pre-assigned to each of such words as their default importance score for the purpose of determining the likelihood of making a purchase when such words are used under certain context.

Another embodiment of the present invention is to identify words or phrases that indicate a degree of intensity for need, desire, which in turn indicate the degree of urgency for action of purchasing certain goods/service. For example, English words or phrase such as “extremely”, “very”, “absolutely”, etc. can be identified as belonging to this category.

Another embodiment of the present invention is to identify certain attributes of goods or services, such as their price range, availability, consumption patterns, durability, frequency of purchase, etc.

The above are exemplar categories of attributes that can be identified and associated with words or phrases in a language, and recorded in a dictionary. These examples are not exhaustive, but illustrate the principle of the methods of the present invention. Many other attributes can be identified in a similar way and can be used for the same purpose without deviating from the principle and spirit of the present invention as exemplified above.

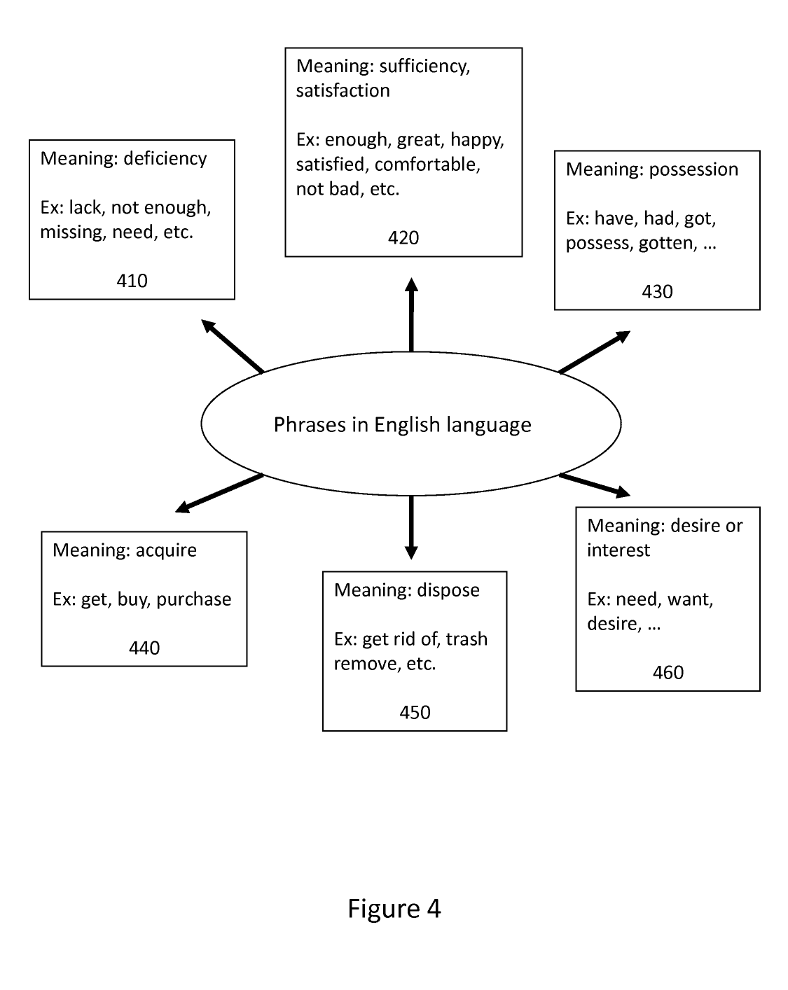

FIG. 4 illustrates exemplar groups of words in the English language and their semantic attributes in one embodiment of the present invention. The phrases can be placed in groups that have similar meanings, or labeled as such. For example, words in Group 410 are all related to the concept of deficiency, while words in Group 450 are all related to the concept of disposal. Words can be identified in one or more groups, such as the word “need” appearing in Group 410 as well as Group 460. The illustrated groupings or labeling are just one method of identifying semantic attributes of words and terms, and such a method is not limited to just the illustrated groups in FIG. 4.

### Semantic+Grammatical Analysis

The semantic analysis as described above can be used either alone or in conjunction with the grammatical analysis of the user expression, as described below.

In some embodiments, both grammatical attributes and semantic attributes are used for the determination of the likelihood of a user making a purchase based on a user expression. For example, compare the following two sentences.

(11) I don't like my computer.
(12) I don't like computers.

In (11), the presence of the word “my”, with its grammatical attributes of being a first person possessive pronoun as a modifier of the head noun of “computer”, indicates that the semantic attribute of dissatisfaction indicated by the meaning of “don't like” is associated with a specific instance of computer that is currently in the user's possession. With such attributes, the present invention can algorithmically determine that the user is likely to purchase a different computer in order to reduce his or her dissatisfaction with his or her current computer. However, in (12), with the absence of the word “my”, the semantic attribute of dissatisfaction indicated by the meaning of “don't like” is associated with the commodity of computer as a whole, and is not necessarily currently in the user's possession. In such a case, purchasing a computer is not likely to reduce the user's dissatisfaction, thus the likelihood of the user purchasing a computer is low.

Also as illustrated above, other grammatical attributes such as first person, second person, or third person subject or object, and grammatical attributes such as the present tense, past tense, or future tense, etc., of verbs in the English and other languages can all be used to determine the likelihood. For example, an expression with a first person subject using a present or future tense verb form indicating an intention to acquire something, such as “I will buy a computer soon”, can be assigned a much larger importance score than a third person subject using a past tense verb form, such as in “He bought a computer last week”. The difference can be identified by the future tense of the verb “will buy” and the past tense of the verb “bought”, as well as the time expression of “soon” and “last week”.

Below is another example of combining the grammatical and semantic attributes with the sentence structure Subject+Linking verb+Adjective. In the following example sentences,

(13) My camera is amazing.
(14) His camera is amazing.
(15) My camera is terrible.
(16) His camera is terrible.

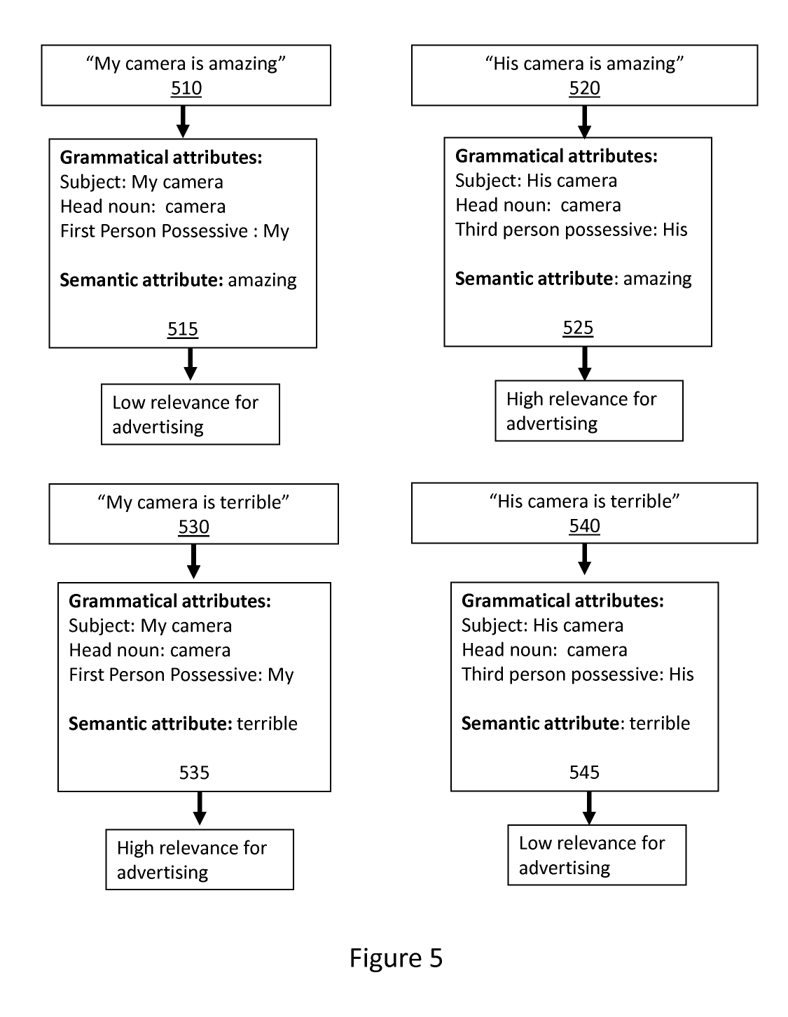

For a computer system to estimate the likelihood of the user making a purchase of a camera, both grammatical and semantic attributes need to be identified. FIG. 5 illustrates an embodiment of the present invention which identifies the grammatical and semantic attributes of the above four example sentences to determine the advertising relevance.

Sentence (13) is shown as sentence 510 in FIG. 5. Grammatical and semantic analyses are performed to obtain the grammatical and semantic attributes in 515. The subject of sentence 510 is “My camera” with a head noun of “camera” and a first person possessive modifier of “my”. The semantic attribute is “amazing”, which signifies a state of satisfaction.

Sentence (14) is shown as sentence 520 in FIG. 5. Grammatical and semantic analyses are performed to obtain the grammatical and semantic attributes in 525. The subject of sentence 520 is “His camera” with a head noun of “camera” and a third person possessive modifier of “his”. The semantic attribute is “amazing”, which signifies a state of satisfaction. Sentence (15) is shown as sentence 530 in FIG. 5. Grammatical and semantic analyses are performed to obtain the grammatical and semantic attributes in 535. The subject of sentence 530 is “My camera” with a head noun of “camera” and a third person possessive modifier of “my”. The semantic attribute is “terrible”, which signifies a state of dissatisfaction or frustration.

Sentence (16) is shown as sentence 540 in FIG. 5. Grammatical and semantic analysis are performed to obtain the grammatical and semantic attributes in 545. The subject of sentence 540 is “His camera” with a head noun of “camera” and a third person possessive modifier of “his”. The semantic attribute is “terrible”, which signifies a state of dissatisfaction.

Using these grammatical and semantic attributes, a rule can be set up to produce an estimate of the likelihood of the speaker purchasing a camera. For example, one rule is to first identify the subject of the sentence, and assign a larger weight value or importance value to a head noun having a first person possessive pronoun as its modifier, and if the predicative of the sentence is carrying a negative connotation, or can be identified as having a semantic attribute of signifying a dissatisfaction or frustration, then, increase the importance score of the head noun, especially, if the head noun matches a commodity name that can be advertised to the user. With this rule, sentence 530 can be identified as indicating a higher likelihood of the speaker purchasing a camera and having a higher relevance for advertising cameras than sentence 540. Sentence 540, or its head noun of “camera” can be assigned a smaller weight value or importance value because the modifier of the head noun in the subject is a third person possessive pronoun, with the same predicative. This is an example of determining advertising relevance based on the grammatical and semantic attributes with context information.

In some embodiments, words or phrases in a language are first organized into different groups based on their semantic attributes, and the relevance score is determined by identifying the group membership of the words or phrase in the expression, as well as the grammatical context of the words or phrases, without specifically adding numerical values for each word.

For example, a rule can be set up to determine that if the following conditions are met, then a high relevance score can be assigned to words or phrases in the expression: a) if the modifier of the subject head noun is a first person possessive pronoun such as in sentence (15); b) if the head noun matches an advertisable word, or is a member of advertisable keyword group; c) if the predicative of the linking verb is a member of the adjective group that carries a negative connotation or signifies a dissatisfaction or frustration d) if the linking verb “is” is in a present tense. This rule does not require assigning importance score to a term as a function of the importance values associated with other terms in the expression. It only checks if certain words are members of certain term groups, or is labeled as such, such as the group of adjectives that carry a negative connotation, or signify dissatisfaction or frustration, or pronouns that signify a possession of a commodity, such as the first person possessive pronoun of “my”, and certain context information, such as a head noun is modified by a personal pronoun, or the subject has a linking verb and a predicative, etc. An importance value can be assigned to the entire expression, and words or phrases that match an advertisable keyword can be selected if the importance value of the expression is above a threshold. This is equivalent to using ad hoc rules for each specific combination of words in certain groups in determining relevance.

Similar to the other embodiments as described above, in this embodiment, sentence (14) can still be determined to indicate a higher likelihood of the speaker purchasing a camera than sentence (13), due to the presence of the third person possessive pronoun “his”, and the adjective “amazing” being in a adjective group for adjectives carrying positive connotation or its semantic attribute of signifying an admiration or a desire to acquire something, and the grammatical context of the adjective “amazing” being a predicative of a present-tensed linking verb “is”.

As is described, using a combination of the grammatical and semantic attributes of the words and phrases in an expression can enhance the accuracy of the estimation of the likelihood of a user making a purchase based on the user's expressions. When both the grammatical and semantic attributes are used, importance scores for the individual words or phrases can be assigned using the methods as described above for embodiments that use the grammatical or semantic attributes separately, or can be adjusted for the combination of the two types of attributes. The likelihood score of the expression or a target term in the expression can be calculated using a similar method of addition or multiplication or a combination of both as described earlier, based on the importance scores assigned to the individual words or phrases in the expression.

It should be noted that the above are only examples, and more categories of semantic attributes and methods of combining with grammatical attributes can be used for the purpose of determining the likelihood of a user making a purchase based on the user's expression.

In addition to the attributes described above, sentence patterns or sentence structure types such as questions or imperatives or exclamations can all carry information about user's needs, interests, etc, and can thus be used for detecting such intent for advertising or recommendation purposes. For example, if a user asks questions such as “Does anyone have a golf club that I can borrow?” or “Do you know whether this type of fertilizer can be used for tomatoes?” etc., the user's need for a golf club or a fertilizer for growing tomatoes can be detected, and the likelihood of the user purchasing a related product can be estimated to a certain degree. Furthermore, certain imperative sentences can also indicate user interest or intent. For example, when a user says “Let's watch a movie this weekend”, the likelihood of the user purchasing a movie ticket can also be estimated to a certain degree. Moreover, certain exclamation sentences can also indicate a user's interest or intent. For example, when a user says “Go Lakers!” the user's interest in watching a sports game can be estimated to a certain degree.

On the other hand, other grammatical elements such as negation words like “no”, “not” in the English language, can also be used to make such estimate. For example, if the user says “Don't buy an iPad”, then the degree of the user's interest or intent in buying an iPad can also be estimated.

Furthermore, the user expressions can be in original text format, or as an audio or video transcript from a conversation or comments.

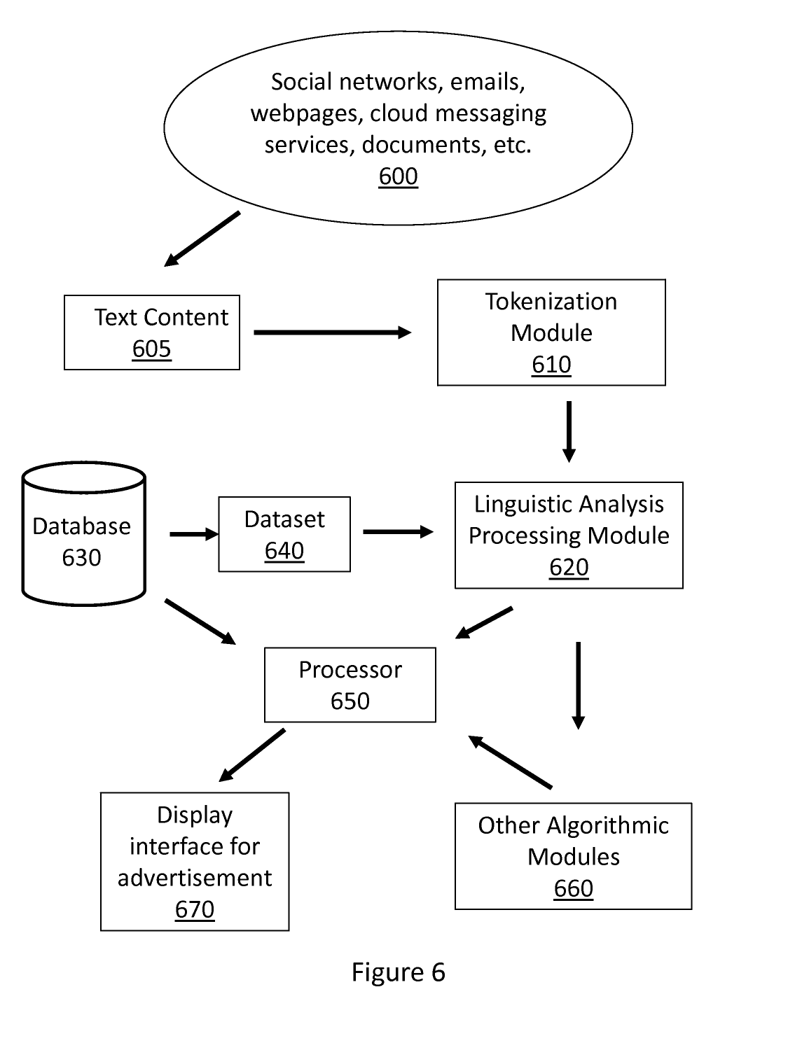

FIG. 6 illustrates a system configuration for one embodiment of the present invention. In general, a text content 605 can be obtained from content source 600, which can comprise of many different sources, including social networks, emails, webpages, mobile or non-mobile text messaging, documents, etc. Text content 605 is processed by tokenization module 610 to extract words or phrases, optionally, with a syntactic parser. The extracted terms are then sent to the linguistic analysis module 620, which can use a dataset 640 stored in a database 630 to assign numerical values to terms, or use algorithms to determine the values. Optionally, linguistic analysis module 620 can check group membership of terms. The results are processed by processor 650, optionally along with the results from other algorithmic modules 660 to determine the likelihood of a user being interested in or having an intention to purchase something, and if a relevant advertisement should be displayed in display interface 670 to a user. Display interface 670 can be within the same display interface that is displaying the content source 600, or in a separate interface.

### Selling Advertisement Time or Space Based on Relevance

The methods for quantitatively estimate the likelihood of a user making a purchase or being interested in something based an expression the user has produced, and use that quantitative measure as a relevance score to select relevant advertisement to be displayed can be applied in many other areas.

In addition to display highly relevant advertisement, the relevance score can also be used for determining the price charged to the advertiser for the time or space of displaying the advertisements. For example, for a given commodity, if the relevance score is determined to be high, the time or space sold to the advertiser can be relatively high to match the potentially better effect of advertisement; and if the relevance score is determined to be medium or low, the price for displaying an advertisement can be relatively low to reflect the possibly reduced advertising effect.

Conventional online advertising methods, such as advertisement keyword auction method based on search query or social network comments or email contents, are mainly based on the presence or absence of a given keyword in a user expression; and such keyword are auctioned to the advertisers based on popularity. Such methods provide less information to the advertisers as to how effective the keywords can be for a particular advertisement. For example, if a user's expression contains the keyword “camera”, advertisers of cameras will likely assume that it is highly relevant to an advertisement of the product of camera, and price for placing such an advertisement can be high. However, not all expressions containing the word “camera” are highly relevant to advertising for the product of camera. For example, if a user writes a comment on a social network or email “His camera is terrible”, then, as can be determined by the methods described in the present disclosure, the likelihood of the user purchasing a camera in this case is low. With the conventional approaches, this type of difference cannot be detected, and the advertisers are not well served if they pay a high price only because the user mentioned the keyword of “camera”.

However, in the present invention, the relevance score of the keyword for advertising based on a particular user expression can be made available to the advertiser, and the price for bidding for an advertisement for the keyword can be dependent on the relevance score as described above that indicates the likelihood of the user purchasing a camera. High prices can be charged for high relevance, and low price can be charged for low relevance. Since a lower relevance does not necessarily mean it is not relevant, there is still a good chance that the advertisement can yield a positive result. But the advertiser can determine whether a keyword with specific relevance score based on a specific user expression is worth the price for advertising. This way, the advertisers can be served in a more reasonable way.

### Facilitating Group Purchase Advertising

Another embodiment in the present invention is to use the relevance score so determined to serve promotional sales with group purchase prices. This method can be especially effective in a social network or email advertising environment or other communications channels, as well as search engines. In such environments, sources where certain expressions are generated can usually be identified whether anonymously or not. Such sources include users' social network pages or email pages; and advertisements can be displayed to such users in a relatively more persistent user interface or more persistently retained open pages.

In some embodiments, the methods of identifying the likelihood of user interest or purchasing something can be applied to multiple users within a given period of time. For example, on a social network, numerous users are writing comments at any given time; and with emails, numerous email users are writing emails at any given time. In such environments, all or part of the comments or emails can be analyzed using the methods described above, and if a particular commodity name is found to be relevant or with a high likelihood of user making a purchase, this information can be used to inform the providers of the commodity, such that the commodity provider can decide whether this is a good chance to launch a promotional campaign by offering a group purchase price discount to the users. Since users of social networks or emails or other digital media who have expressed such intent are often traceable, either anonymously or not, group purchase advertisements can be displayed to the users who have expressed such intent to purchase the commodity.

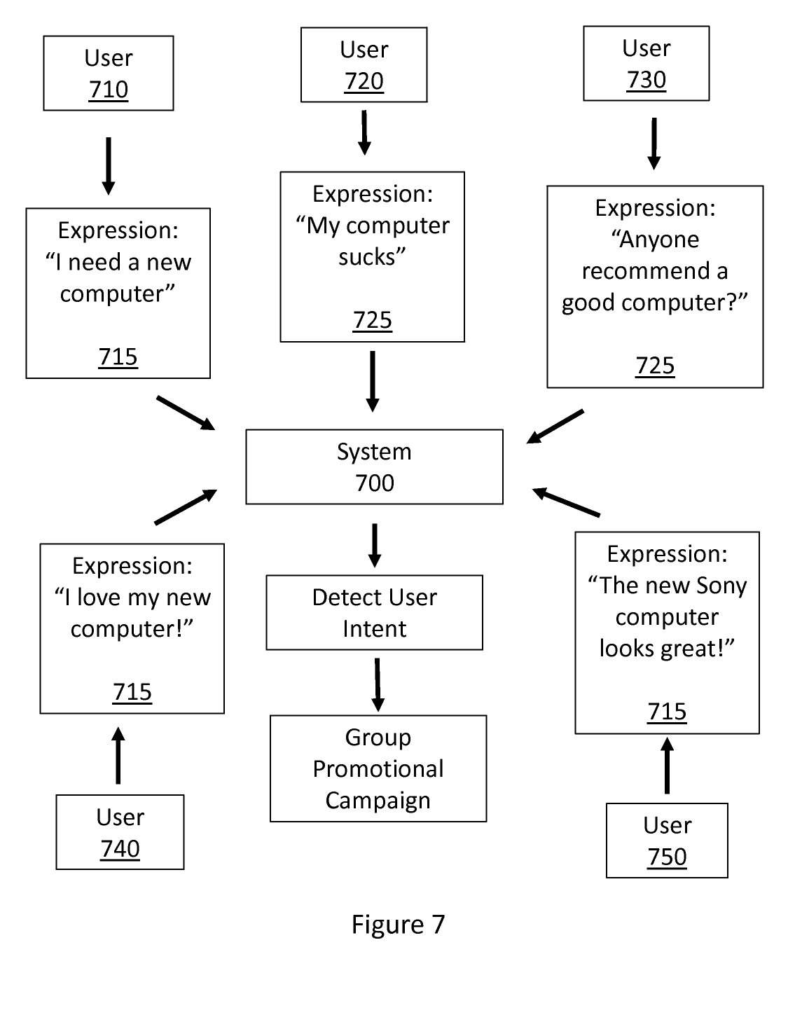

FIG. 7 is an illustration of one embodiment of the present invention where expressions from multiple users are analyzed to determine if a group discount or a promotional campaign should be launched. Users 710, 720, 730, 740, or 750 can each be a user of a social network, email service, cloud messaging service, instant messaging service, commenter on a blog or discussion forum, etc. An expression from each user's content is extracted and analyzed by system 700 to determine user interest or intention, and to determine if any relevant advertising can be associated with each expression. System 700 can be one embodiment of the system as described above. The extracted expressions can be obtained at different times in a given time period. Each expression involves the term “computer”, and if the system determines that enough expressions involving the word “computer” merit advertising, and if the number of users having produced such expressions exceed a threshold, then a promotional campaign with a group price discount for computers may be initiated and relevant advertisements and recommendations can be displayed for the group of users.

Compared to the conventional approach of merchants advertising group discount offerings to solicit response from users whose intent is not known, the method of the present invention is based on known information from actual user expressions, thus can better target the users and more importantly, better serve both consumers and merchants.

### Automatically and Dynamically Creating or Modifying a User Profile

The methods of performing grammatical and semantic analysis as described in the present invention can also be used to automatically and dynamically create or modify a user profile regarding the user's interest and other aspects. User expression produced by email or social network users can be analyzed from time to time, and as is described above, in certain cases, the estimation of the likelihood of user purchasing a commodity is based on the detection of user's interest in terms of what the user likes or does not like, what the user admires, or abhors, etc. such information can be used to automatically or dynamically build up a user profile or modify an existing one. Often when a user signs up an email service or a social network, the user may not willingly or completely disclose what his or her real interest is for privacy concerns, and the user's interest can change. Thus, targeted advertising to the user based on the static information provided by the user may not always be accurate in determining what the best advertisement is to serve. However, using the methods of the present invention as described above, a user's actual interest can be detected from the expressions the user makes, such as the comments on a social network, or emails. A dynamic user profile can be built up within a period of time when enough data is gathered, and the automatically detected topics of user interest can be added to the existing user profile to better serve the user or user community, such as making relevant recommendations or suggestion, as well as to better serve the commodity providers.

### Automatically and Dynamically Suggesting Friends or Groups for Social Network Users

With the ability of the present invention in detecting user interest, common topics of interest among multiple users can be identified. The results can be used to facilitate user group or community formation. In a social network environment, in addition to the static user profile created by the users, automatically and dynamically identified user interest can also be used to make suggestions for user to connect to like-minded people, or form discussion groups, even though some users never explicitly disclosed certain topic of interest. For example, a user may not specify in the user profile that he or she is interested in politics, but the user may actually spend a lot of time discussing about politics on a social network. As is described above, the method of the present invention can be used to analyze multiple users at the same time or within a specific time period. If many users are talking about something similar or sharing some similar views, such talks can usually be limited to the user's own friend circle. However, using the methods of the present invention, multiple users talking something similar can be discovered simultaneously, and common topics can be identified and user groups can be suggested to the users sharing similar views, such that, new user groups can be formed to expand the users friend circle, or to connect users with like-minded people.

The above are only examples of the methods and applications. The presently disclosed system and methods can also be applied to many other environments without deviating from the spirit of the principles and the methods described above.

What is claimed is:

1. A method for selling electronic advertising space or time to advertisers based on a relevance score, and for group purchase, detecting user intent or interest, building a user profile, and making a suggestion, comprising:
obtaining a user expression from social network comments or emails or other communication channels, wherein the user expression can be in a original text format, or an audio or video transcript from a conversation or comment, or other contents containing text, wherein the expression comprises a first term and one or more second terms;
identifying a first term in the expression, wherein the first term is associated with the name of a commodity or a topic of interest;
identifying a grammatical attribute or semantic attribute associated with one or more terms in the expression including the first or the second terms;
calculating a score for the first term based on the grammatical or semantic attributes associated with the one or more terms, wherein the score can be used to indicate the likelihood of the user purchasing the commodity or being interested in the topic; and
selecting or outputting the first term if the score is above a threshold.

2. The method of claim 1, wherein the score can be used as a relevance score for advertising the commodity or the topic of interest, the method further comprising:
selling or auctioning a time or space for advertising the commodity or the topic of interest at a price based at least on the relevance score.

3. The method of claim 1, wherein multiple user expressions are obtained from multiple users within a given period of time, wherein the first term is the same or similar among the expressions produced by the multiple users, the method further comprising:
informing or allowing an advertiser to promote the commodity or the topic of interest with a group purchase price based at least on the number of users each having produced an expression wherein the score of the first term is above a threshold.

4. The method of claim 1, further comprising:
creating or modifying a user profile based on the first term as indicating the name of a thing that the user is likely to be interested in.

5. The method of claim 1, wherein multiple expressions are obtained from multiple users, the method further comprising:
identifying a first user and a second user each having produced an expression containing the first term or a term similar or associated with the first term, wherein the score of the term is above the threshold; and
informing the first user about the second user having a common interest represented by the first term or the term that is similar or associated with the first term.

6. The method of claim 5, further comprising:
making a suggestion or recommendation to the first user or the second user for establishing a connection between the first user and the second user, or to form a group or community based on the common interest.

7. The method of claim 1, wherein the grammatical attributes include parts of speech and grammatical roles of a term in an expression, wherein the parts of speech comprise at least a noun, verb, adjective, adverb, preposition, pronoun, conjunction, exclamation, determiner, wherein the grammatical role comprises at least a subject, predicate, direct object, indirect object, linking verb with predicative, and verbal complement and sentential complement of a sentence, and head and modifier of a multi-word phrase, first person, second person, third person nominative, accusative, and possessive pronouns, and other verbal elements indicating past, present, or future, such as the present tense, past tense, and future tense, and their respective perfect tense in the English language, and negation; and
wherein the semantic attributes comprise one or more meanings associated with a term, wherein a meaning can indicate at least a need, a deficiency, a sufficiency, a desire, an interest, an opinion, a state of possession, a state of satisfaction or dissatisfaction, an intention to acquire or to remove, a degree of urgency, a degree of intensity, a point of time in the past, present, or future, or a time duration, or a source or a target of an action or intention, or the price range of a commodity, the availability, durability, frequency of purchase, or consumption patterns of certain goods or services, wherein the first term or information about the point of time in the past, present, or future can also be obtained from a user's electronic calendar.

8. A method for advertising to a group of users, comprising:
obtaining user expressions produced by multiple users of social media or email or other communication methods;
identifying a commodity name contained in the expressions;
calculating a score for the commodity name based on the context of the commodity name in the expression, wherein the score can be used as an estimate of the likelihood of the user purchasing the commodity;
counting the number of users having produced an expression containing the commodity name, wherein the score of the commodity name is above a threshold; and
informing or allowing an advertiser to promote the commodity with a group purchase price based at least on the number of users each having produced an expression containing the commodity name with the score of the commodity name above the threshold.

9. The method of claim 8, wherein the user expressions produced by the users are produced within a given time period.

10. The method of claim 8, wherein the context of the commodity name in the expression comprises terms associated with grammatical attributes, wherein the grammatical attributes include parts of speech and grammatical roles of a term in an expression, wherein the parts of speech comprise at least a noun, verb, adjective, adverb, preposition, pronoun, conjunction, exclamation, determiner, wherein the grammatical role comprises at least a subject, predicate, direct object, indirect object, linking verb with predicative, and verbal complement and sentential complement of a sentence, and head and modifier of a multi-word phrase.

11. The method of claim 10, wherein the grammatical attribute further comprises first person, second person, third person nominative, accusative, and possessive pronouns, and other verbal elements indicating past, present, or future, such as the present tense, past tense, and future tense, and their respective perfect tense in the English language, and negation.

12. The method of claim 8, wherein the context of the commodity name in the expression comprises terms associated with semantic attributes, wherein the semantic attributes comprise one or more meanings associated with a term, wherein a meaning can indicate at least a need, a deficiency, a sufficiency, a desire, an interest, an opinion, a state of possession, a state of satisfaction or dissatisfaction, an intention to acquire or to remove, a degree of urgency, a degree of intensity, a point of time in the past, present, or future, or a time duration, or a source or a target of an action or intention, or the price range of a commodity, the availability, durability, frequency of purchase, or consumption patterns of certain goods or services.

13. The method of claim 12, wherein the commodity name or information about the point of time in the past, present, or future can be obtained from a user's electronic calendar.

14. A system for targeted advertising based on user intent detection, comprising:
a user interface configured to display an advertisement to a user; and
a computer processing system configured to obtain a user expression produced by a user, wherein the user expression can be in a original text format, or an audio or video transcript from a conversation or comment, or other contents containing text, wherein the expression comprises a first term and one or more second terms; wherein the user expression can be a comment on a social network, an email message, or other contents containing text;
to identify a first term associated with the name of a commodity or a topic of interest contained in the expressions;
to calculate a score for the first term based on the grammatical or semantic context of the first term in the expression, wherein the grammatical or semantic context are used to determine the likelihood of the user being interested in the topic or purchasing the commodity, wherein the score can be used as an estimate of the likelihood; and
to select or output the first term if the score is above a threshold, optionally also to output the scores associated with the term.

15. The system of claim 14, wherein the computer processing system is further configured to display an advertisement of the commodity or topic of interest in a user interface.

16. The system of claim 14, wherein the grammatical context of the first term in the expression comprises one or more terms including the first or the second terms each associated with a grammatical attribute, wherein the grammatical attribute includes parts of speech and grammatical roles of a term in the expression.

17. The system of claim 16, wherein the parts of speech comprise at least a noun, verb, adjective, adverb, preposition, pronoun, conjunction, exclamation, determiner, wherein the grammatical role comprises at least a subject, predicate, direct object, indirect object, linking verb with predicative, and verbal complement and sentential complement of a sentence, and head and modifier of a multi-word phrase.

18. The system of claim 16, wherein the grammatical attribute further comprises first person, second person, third person nominative, accusative, and possessive pronouns, and other verbal elements indicating past, present, or future, such as the present tense, past tense, and future tense, and their respective perfect tense in the English language, and negation.

19. The system of claim 14, wherein the semantic context of the first term in the expression comprises one or more terms including the first or the second terms each associated with a semantic attributes, wherein the semantic attribute comprises one or more meanings associated with a term, wherein a meaning can indicate at least a need, a deficiency, a sufficiency, a desire, an interest, an opinion, a state of possession, a state of satisfaction or dissatisfaction, an intention to acquire or to remove, a degree of urgency, a degree of intensity, a point of time in the past, present, or future, or a time duration, or a source or a target of an action or intention, or the price range of a commodity, the availability, durability, frequency of purchase, or consumption patterns of certain goods or services, wherein the first term or information about the point of time in the past, present, or future can also be obtained from a user's electronic calendar.

20. The system of claim 14, wherein the advertisement is displayed when a user is using a social network, an email, instant messaging, SMS, or using a blog, writing a comment or review, or using a mobile, handheld, or desktop computing or communication device, or other places wherever a user interface is available to display a relevant advertisement.
